(19) United States
(12) Patent Application Publication
(10) Pub. No.: US 2019/0080300 A1
(43) Pub. Date: Mar. 14, 2019

(54) CASH-EQUIVALENT DEVICE FOR DIGITAL CURRENCIES

(71) Applicant: JORDAN STOJANOVSKI, NEW YORK, NY (US)

(72) Inventor: JORDAN STOJANOVSKI, NEW YORK, NY (US)

(21) Appl. No.: 16/128,108

(22) Filed: Sep. 11, 2018

Related U.S. Application Data
(60) Provisional application No. 62/558,312, filed on Sep. 13, 2017.

(51) Int. Cl. G06Q 20/06; G06Q 20/34; G06Q 20/36; G06Q 20/38; G06Q 20/32

(52) U.S. Cl. CPC G06Q 20/0658; G06Q 20/3415; G06Q 20/3278; G06Q 20/3829; G06Q 20/3674

(57) ABSTRACT

An electronic device is provided that acts as cryptocurrency cash for point of sale or service transactional commerce. The electronic device is implemented using a microcontroller that can be manufactured inexpensively and physically handed over from one person to another just like cash. The device can hold cryptocurrency value without allowing the current holder to empty the assigned value of the device and hand the device over to an unsuspecting recipient of a transaction as untampered. This allows for digital cryptocurrency transactions that are instantaneous and which do not incur transaction costs. Cryptographically sound protocols are provided for the manufacturing and issuing of forms of the electronic device, verification of its untampered cryptographic keys and value and finally overtly removing the value to discard and/or reuse the electronic device. A method is provided which facilitates verification whether the electronic is genuine, untampered, and funded with cryptocurrency value.

### CROSS-REFERENCE TO RELATED APPLICATION

This application claims priority of U.S. Provisional Patent Application Ser. No. 62/558,312 filed Sep. 13, 2017, which is incorporated herein by reference.

### FIELD OF THE INVENTION

The invention relates in general to cryptocurrency, cryptocurrency hardware devices, cryptographic protocols which utilize digital signature algorithms, and in particular to an electronic device that acts as cryptocurrency cash for point of sale or service transactional commerce.

### BACKGROUND OF THE INVENTION

A cryptocurrency is a digital or virtual currency that uses cryptography for security. Cryptography involves creating written or generated codes that allow information to be kept secret. Cryptography converts data into a format that is unreadable for an unauthorized user, allowing data to be transmitted without unauthorized entities decoding it back into a readable format, thus compromising the data.

A common algorithm used in cryptography is public key cryptography (PKC) or asymmetric encryption that allows senders and receivers to authenticate each other through the use of key pairs. In PKC, a first key is a public key that anyone can access, while a second key is a private key that only the owner can access. The sender encrypts the information using the receiver's public key. The receiver decrypts the message using their private key. For nonrepudiation, the sender encrypts plain text using a private key, while the receiver uses the sender's public key to decrypt it. Thus, the receiver knows who sent it.

Digital signature algorithms allow the holder of a private key to sign documents cryptographically. The signature can be verified using the signer's public key allowing anyone to verify that the document was signed by the holder of the private key corresponding to the given public key. Elliptic curve digital signature algorithm (ECDSA) is a specific cryptographic digital signature algorithm most widely used in cryptocurrency implementations.

Digital cryptocurrency such as Bitcoin and Ethereum hold agreed and perceived monetary values. Transactions using cryptocurrency are recorded in a blockchain. A blockchain is a digitized, decentralized, public ledger of all cryptocurrency transactions. Constantly growing as ‘completed’ blocks (the most recent transactions) are recorded and added to the blockchain in chronological order. The blockchain allows market participants to keep track of digital currency transactions without central recordkeeping. Each node (a computer connected to the network) receives a copy of the blockchain, which is downloaded automatically. The blockchain serves as a distributed ledger in the form of a public distributed immutable log of transactions divided in blocks. The immutability is cryptographically assured by each block having a reference and one-way hash of its predecessor. Hash functions do not employ a key and are also called one-way functions. Hash functions are mainly used to ensure that a file has remained unchanged. Furthermore, the prevention of double-spending of funds is achieved by proof-of-work or a proof-of-stake cryptographic protocol in which a malicious double-spender of funds would have to overpower the majority of the participants in the system, making it practically impossible. The funds associated with cryptocurrency are indirectly held in addresses possibly known to the public derived from private keys known only to the holder of the funds.

Currently, transactions conducted with physical crypto coins have an exposed printed cryptocurrency address and the corresponding private key hidden behind a supposedly tamper-proof holographic cover seal. However these physical crypto coins are quite unsafe, as the holographic cover seal can be opened and the private key can be read, in which case another such coin or counterfeit coin can be produced using the stolen private key. The user would not find out until it is too late. Cryptocurrency hardware wallets allow safeguarding of cryptocurrency funds holding private keys and their proper handling in order to issue transactions. Typically the user of the hardware wallet has to authenticate using their credentials. Thus, handing the hardware wallet to another user presents danger to the recipient that the previous owner may have copied (backed up) the private keys or issued transactions not yet recorded.

An additional problem associated with the use of bitcoin and other cryptocurrencies is transaction costs or fees charged for a purchase or payment. Currently, credit card fees that range between 2-3% are paid by the merchant and not the purchasing consumer. However, the cost per transaction with bitcoin is over nine U.S. dollars of which 10.08% is transaction fees and the remaining cost is per transaction regardless of transaction size (blockchain.info Apr. 15, 2017). Bitcoin creation is based on mining and involves solving a computationally difficult puzzle to discover a new block, which is added to the blockchain, and receiving a reward in the form of few bitcoins. The block reward was 50 new bitcoins in 2009; it decreases every four years. As more and more bitcoins are created, the difficulty of the mining process—that is, the amount of computing power involved—increases. The mining difficulty began at 1.0 with Bitcoin's debut back in 2009; at the end of the year, it was only 1.18. As of April 2017, the mining difficulty is over 4.24 billion. Once, an ordinary desktop computer sufficed for the mining process; now, to combat the difficulty level, miners must use faster hardware like Application-Specific Integrated Circuits (ASIC), more advanced processing units like Graphic Processing Units (GPUs), etc.

Mining costs are not going down, and this is by design. With time, it gets increasingly more difficult to mine a block to compensate for the computers becoming more powerful. Transaction fees are an incentive to the miner to get a transaction ahead of the line. The high transaction costs dictate that Bitcoin is suited to only process large transactions and not for everyday use.

Thus, there exists a need for a system and method for an electronic device that acts as cryptocurrency cash for point of sale or service transactional commerce that is secure and virtually eliminates the high transaction costs associated with cryptocurrency.

### SUMMARY OF THE INVENTION

A cash equivalent device for digital currencies is provided. The cash equivalent device includes a microcontroller, a memory in electrical communication with the microcontroller, and an antenna in electrical communication with the microcontroller. The cash equivalent device securely holds a designated cryptocurrency value for circulation, and upon physical handover of the cash equivalent device from a first user to a second user transfers ownership of the designated cryptocurrency value as cash currency, while eliminating the ability of the first user to access the funds stored on the device after handing over the device to the second user.

A system for circulation of a digital currencies as a cash equivalent is provided. The system includes a cash equivalent device for the circulation of digital currencies, where the cash equivalent device securely holds a designated cryptocurrency value for circulation, and upon physical handover of the cash equivalent device from a first user to a second user transfers ownership of the designated cryptocurrency value as cash currency, while eliminating the ability of the first user to access the funds stored on the device after handing over the device to the second user. The cash equivalent device includes a microcontroller, a memory in electrical communication with the microcontroller, an antenna in electrical communication with the microcontroller, and a first private key generated by the cash equivalent device and stored in the memory. The first private key is never divulged during an entire lifetime of circulation of the cash equivalent device, and a cryptocurrency address is generated from the first private key. The system also includes an initialization device of an issuer with a second private key that signs the cryptocurrency address of the cash equivalent device and funds the cryptocurrency address in a blockchain of the digital currency. The system further includes one or more verification devices that conduct a transaction with the cash equivalent device by verifying that the cash equivalent device is genuine and the funded value associated with the cryptocurrency address is available for the transaction.

A method for circulation of a digital currencies as a cash equivalent at a point of sale or for service transactional commerce is provided. The method includes initializing a cash equivalent device with an initialization device of a funder of the cash equivalent device, where in response to powering up of the cash equivalent device via at least one of: near field communication (NFC), Bluetooth Low Energy (BLE), Universal Serial Bus (USB), or One Wire Protocol the cash equivalent device generates a one-time only first private key and stores the first private key in non-volatile protected memory of the cash equivalent device. A cryptocurrency address is generated in the cash equivalent device with the first private key. The initialization device queries the cash equivalent device with the initialization device to obtain the cryptocurrency address and signs the cryptocurrency address with a second private key of the initialization device. Subsequently, the initialization device funds the signed cryptocurrency address in a node of a blockchain of the digital currency.

### BRIEF DESCRIPTION OF THE DRAWINGS

The present invention is further detailed with respect to the following drawings that are intended to show certain aspects of the present invention, but should not be construed as a limit on the practice of the present invention.

FIG. 1 illustrates the basic components of an inventive system for implementing embodiments of the electronic device as a cash equivalent device;

FIG. 2 illustrates an embodiment of the initialization process for the cash equivalent device;

FIG. 3 illustrates an embodiment of the verification process for the cash equivalent device;

FIG. 4 illustrates an embodiment of an emptying and decommissioning process for the cash equivalent device;

FIG. 5 illustrates an embodiment of a verification process after the emptying and decommissioning of the cash equivalent device; and

FIG. 6 is a schematic diagram illustrating an overall view of communication devices, computing devices, and mediums for implementing embodiments of the invention.

### DESCRIPTION OF THE INVENTION

The following description of the inventive embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. The inventive devices are disclosed herein in general with respect to an electronic device that acts as cryptocurrency cash for point of sale or service transactional commerce, but this is not meant to be a limitation on the invention.

The invention has utility as an electronic device that securely holds a designated cryptocurrency value, and upon physical handover from a first user to a second user transfers ownership of this value in the manner of cash currency, while eliminating the ability of the first user to access the funds stored on the device after handing over the device to the second user. Embodiments of the electronic device provide ownership of the cryptocurrency funds only while in physical possession, with no transaction cost, as well as anonymity of the owner. Embodiments of the invention provide a method for handover of cryptocurrency value in which the involved parties do not have to trust each other, but rely on their own verification devices, which can be computers, mobile applications, or standalone devices. In a specific inventive embodiment, an inexpensive stand-alone verification device may be used by merchants without a computer or mobile device.

Embodiments of the electronic device that securely hold a designated cryptocurrency value may be in the form of a credit card, coin, or flexible paper with a flexible circuit contained within.

Embodiments of the inventive method safeguard cryptocurrency funds held by the transferable electronic device, by never divulging the private key during the entire lifetime of circulation of the electronic device. Embodiments of the inventive method allow for independent funding (even multiple times) of the electronic device thus providing for various denominations or values. Methods of verification are provided that confirm that the electronic device is genuine, holds the private keys to the cryptocurrency address and that no one else does, funds are inaccessible to anyone but the holder/owner of the electronic device, and that the funds have not been accessed by any previous holder. An inventive method is provided for extracting the funds from the electronic device thus providing the equivalent of cash backed by cryptocurrency value, as well as for verification and warning to the user that the cryptocurrency value has possibly been extracted from the electronic device. A method is provided for repeated transactions for extraction of the funds in order to prevent possible ill-formed transactions, mistakes and/or expirations of transactions which could result in unintentional permanent loss of funds, as well as a method for allowing very small but safe cryptocurrency transactions without having to trust a third party to facilitate the transactions or lump multiple transactions together.

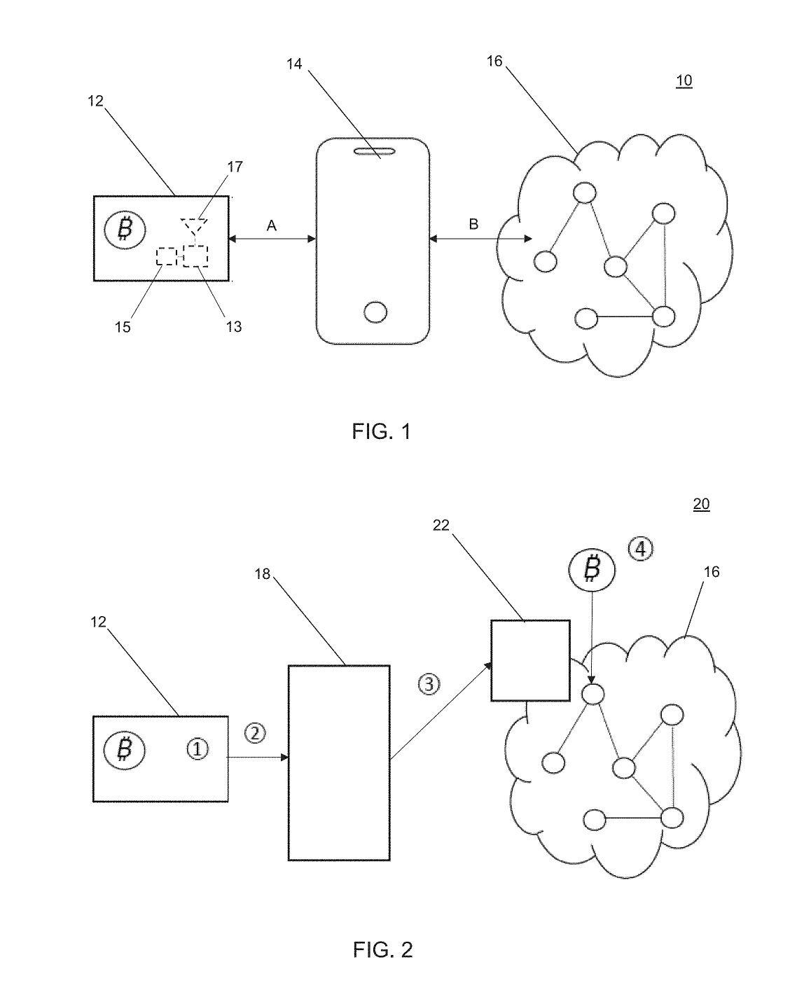

Referring now to the figures, FIG. 1 illustrates the basic components of an inventive system 10 for implementing embodiments of the electronic device 12 as a cash equivalent device. The cash equivalent device 12 has a small microcontroller 13 with protected memory 15 and an antenna 17. A manufacturer produces the cash equivalent device 12, loads the firmware, initializes the device 12, which results in generation of device's 12 own address to which cryptocurrency value is independently transferred by the manufacturer or a third party. Subsequently, the cash equivalent device 12 is handed from one user to another, in other words from a payer to a payee. Upon each such handover, both the payer and the payee can use their own verification device 14 to check whether the cash equivalent device 12 is genuine and check the balance of funds the cash equivalent device 12 holds. The cash equivalent device 12 may communicate with the verification device 14 wirelessly via near field communication (NFC) or other wireless/wired protocols (bidirectional arrow A) illustratively including Bluetooth Low Energy (BLE), or using a wired protocol such as Universal Serial Bus (USB), One Wire Protocol, or similar. This communication is intended to occur upon initial funding of the cryptocurrency address, upon each handover of the cash equivalent device 12 from one user to another (payment) and upon the final end of life transaction of the cash equivalent device 12. The cash equivalent device 12 does not have a network connection on its own, but the verification device 14 does (bidirectional arrow B). The blockchain of nodes is shown as cloud 16 that holds information related to the cryptocurrency. The verification device 14 as shown is a mobile phone with an application (app) installed to interact with the cash equivalent device 12. It is appreciated that other devices illustratively including a tablet, laptop, desktop computer, and other dedicated devices may perform the verification function. The cash equivalent device 12 receives power via NFC in order to perform operations. If the cash equivalent device 12 is not in contact with the verification device 14, the cash equivalent device 12 has no power, and the cash equivalent device 12 is passive.

FIG. 2 illustrates an embodiment of the initialization process 20 for the cash equivalent device 12. Before the first use and introduction into circulation, the cash equivalent device 12 has to be initialized. When the cash equivalent device 12 is manufactured and loaded with the proper firmware, the non-volatile memory 15 of the device 12 is protected against reading using the microcontroller's 13 feature which controls read access. Subsequently, the issuer powers up the cash equivalent device 12 for the first time with the initialization device 18 of the issuer, and the cash equivalent device 12 generates a one-time only private key and stores the private key in its non-volatile protected memory 15 (Step 1). The generated private key of the cash equivalent device 12 may be a 256 bit random number that becomes the private key of the device 12 that is never disclosed to anyone (Step 1). Non-limiting examples of algorithms used to generate the private key may illustratively include Yarrow, Fortuna, or Linux “/dev/random”. The algorithms generate a random private key from a signal provided by a white noise generating electronic circuit fed to a designated analog input of the microcontroller 13 or by internal circuitry inside the microcontroller 13 able to generate such noise. The purpose of this circuit is to provide a random white noise signal with high entropy, so that the generated private key cannot be easily guessed. Such circuit may be implemented using a zener diode shot noise generator. The private key may then be stored in the microcontroller's non-volatile memory 15 and protected against malicious reading, which is provided as a memory-protection feature of the microcontroller 13. This private key is used internally and is never revealed by the cash equivalent device 12, and there is no authorized user that can extract this key.

The initialization device 18 then asks the cash equivalent device 12 for its cryptocurrency address (Step 2). The initialization device 18 signs this cryptocurrency address using the initialization devices 18 own private key, and gives the signature to the cash equivalent device 12 to store. The initialization device 18 also publishes this address and signature to the manufacturers' web site 22 (Step 3). The cash equivalent device 12 generates or calculates a cryptocurrency address from the private key of the cash equivalent device 12, and communicates the cryptocurrency address to the issuer (Step 2). This becomes the cryptocurrency address that the device 12 “owns”. The issuer signs this address using the issuer's private key (Step 3) and publishes the address to a website 22 in order to vouch that the cash equivalent device 12, which provides this address upon request, is a genuine one. This is a nonessential step, but was created for a measure of additional confidence. This signature is optionally communicated to the cash equivalent device 12 and stored in its non-volatile memory 15, so that any verifier can see that the cash equivalent device 12 is genuine (signed by the issuer) without communicating to the issuer. The address is then funded with cryptocurrency (Step 4). It is noted that the cash equivalent device 12 does not know the balance, but anyone can check this balance on the Internet by communicating with a bitcoin full node in 16. A “full node” is a node that contains a copy of the entire blockchain. It is noted that not all interconnected nodes shown in “cloud like” illustration 16 are full nodes, but they are directly or indirectly communicating with the full nodes. The funder does not have to communicate with the cash equivalent device 12. As long as the funder knows the address of the cash equivalent device 12, the funder can fund the device 12 with value independently using an appropriate cryptocurrency payment system.

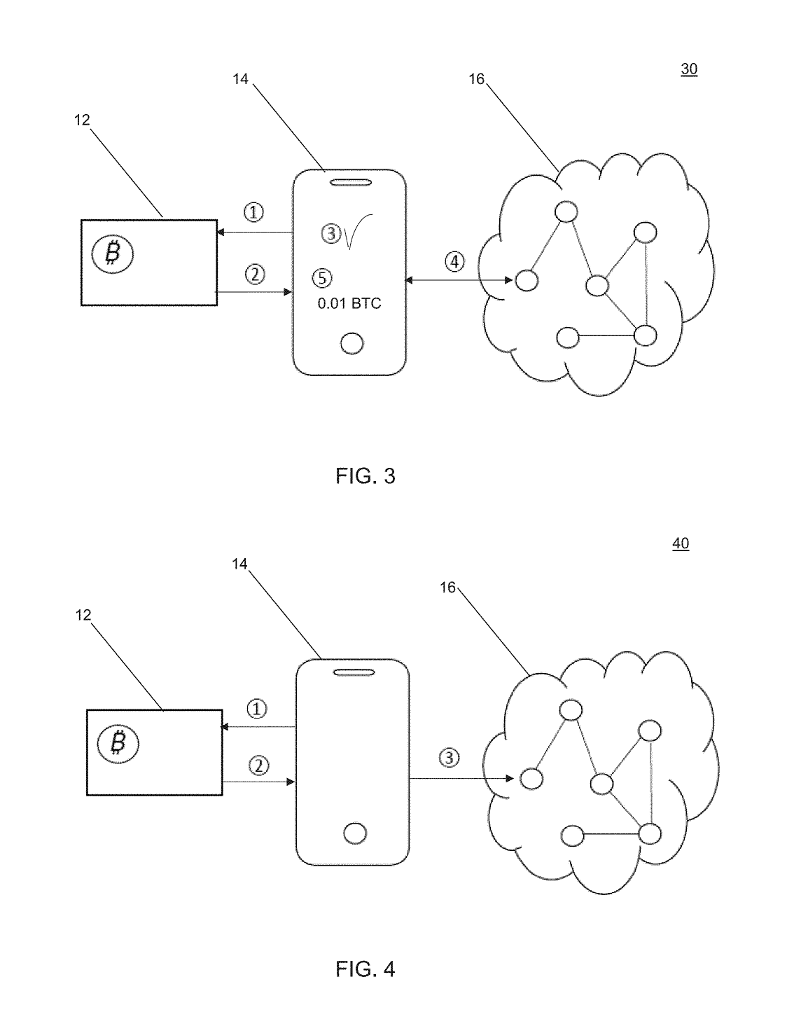

FIG. 3 illustrates an embodiment of the verification process 30 for the cash equivalent device 12. The verification device 14 generates a random message (Step 1), one that the cash equivalent device 12 has not seen before, and sends it to the cash equivalent device 12. Subsequently, the cash equivalent device 12 prepends (puts in front of) a known message to the received random message and signs it with the private key of the cash equivalent device 12 (Step 2). This prepending is necessary in order to avoid a malicious (hacked or counterfeit) verification device from submitting an actual transaction for signing. When the verification device 14 receives the signature, the verification device 14 checks whether the signature matches the address and that the message is signed correctly. This proves that the cash equivalent device 12 actually has the private key, without giving the private key away. The verification device 14 displays a “Verified” checkmark to the user (Step 3). Subsequently, the verification device 14 connects to a full node (blockchain) via the Internet (shown as bidirectional arrow), checks the balance in the given address (Step 4) and displays it to the user on the verification device 14 (Step 5). It is noted that the verification device 14 uses its network connection to verify the funds available in the cryptocurrency address, however for verification of authenticity of the cash equivalent device 12, no network connection is needed.

FIG. 4 illustrates an embodiment of an emptying and decommissioning process 40 for the cash equivalent device 12. At the end of life of the cash equivalent device 12, the funds can be withdrawn at will and the device may be removed from circulation. First the cash equivalent device 12 is verified as described previously in FIG. 3. Once verified, the emptying and decommissioning process is as follows. The verification device 14 generates a transaction which moves the funds from the given address to the address that the user of the verification device 14 designates. The verification device 14 then sends this transaction to the cash equivalent device 12 (Step 1). The cash equivalent device 12 signs the transaction and records internally that it has already signed a transaction. The cash equivalent device 12 then passes the signature back to the verification device 14 (Step 2). The verification device propagates the signed transaction by sending the signed transaction to a cryptocurrency node via the Internet (Step 3).

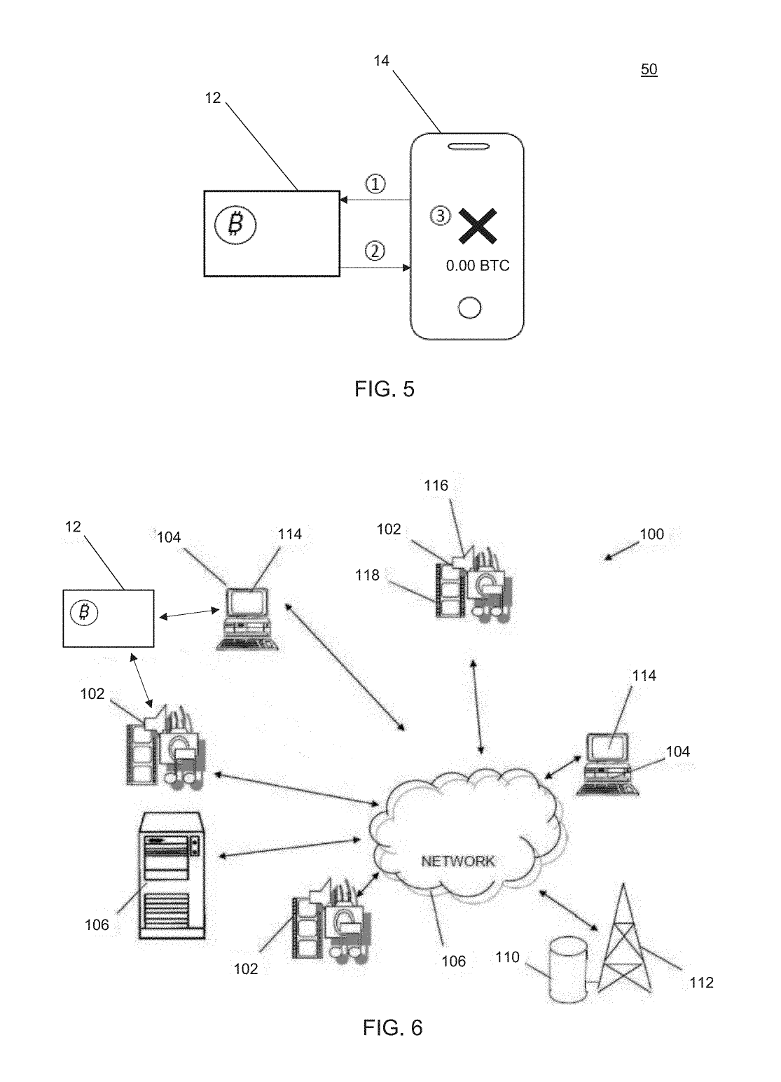

FIG. 5 illustrates an embodiment of verification process 50 after the emptying and decommissioning of the cash equivalent device 12. Once the cash equivalent device 12 has been emptied, device 12 can no longer be trusted to contain value. If the device 12 is touched or brought near to the verification device 14, the verification device 14 will notify the user exactly that. The verification device 14 sends the challenge message to the cash equivalent device 12, as previously described (Step 1). The cash equivalent device 12 prepends a known message to the challenge, signs it and sends it back along with the address and a warning that the device has already signed a transaction (Step 2). The verification device now trusts that the cash equivalent device 12 has the private key (is genuine), but that cash equivalent device 12 also tells that it has signed a transaction. The message “Emptied” is displayed to the user to alert the user that this device cannot be used as a cash equivalent (Step 3).

In actuality, the cash equivalent device 12 does not care what is in the transaction. The cash equivalent device 12 can even sign transactions multiple times, as long as it records internally that it has signed a transaction the first time. This helps in cases where the user makes a mistake in creating the transaction, such as too large, too small (insufficient funds, partial transfer) or even an ill formed transaction. After the emptying and decommissioning of the cash equivalent device 12, the hardware of the cash equivalent device 12 is still usable. The cash equivalent device 12 can be reinitialized again by an issuer and used as a new cash equivalent device with a new address (identity) with a new stored value for use in transactional commerce.

FIG. 6 is a schematic diagram illustrating an overall view of communication devices, computing devices, and mediums for implementing a system and method for the cash equivalent device for cryptocurrencies.

The system 100 includes mobile devices/remote devices illustratively including smart phones, tablets, and portable computing devices 102 and desktop computer devices 104 configured with display capabilities 114 and processors for executing instructions and commands The smart phones 102 are smart phones or smart phones configured as tablets that are wirelessly connected to a network 108. The smart phones, tablets, and portable computing devices 102 typically have video displays 118 and audio outputs 116. The smart phones, tablets, and portable computing devices 102 and desktop computer devices 104 are optionally configured with internal storage, software, and a graphical user interface (GUI) for carrying out elements of initialization device, verification device, and blockchain for cryptocurrencies according to embodiments of the invention. A processor may be used to execute the algorithms outlined above. The network 108 is optionally any type of known network including a fixed wire line network, cable and fiber optics, over the air broadcasts, local area network (LAN), wide area network (WAN), global network (e.g., Internet), intranet, etc. with data/Internet capabilities as represented by server 106. Communication aspects of the network 108 are represented by cellular base station 110 and antenna 112. In a preferred embodiment, the network 108 is a LAN and each remote device represented by smart phones, tablets, and portable computers 102 and desktop device 104 executes a user interface application (e.g., Web browser) to contact the server system 106 through the network 108. Alternatively, the remote devices 102 and desktop devices 104 may be implemented using a device programmed primarily for accessing network 108 such as a remote client.

The software for initialization, verification, and emptying of the cash equivalent device of embodiments of the invention, may be resident on the smart phones, tablets, and portable computing devices 102 and desktop or laptop computers 104, or stored within the server 106 or cellular base station 110 for download to an end user. Server 106 may implement a cloud-based service for implementing embodiments of the platform with a multi-tenant database for storage of separate client data for each separate cash equivalent device service on the platform.

Various modifications of the present invention, in addition to those shown and described herein, will be apparent to those skilled in the art of the above description. Such modifications are also intended to fall within the scope of the appended claims.

Patents and publications mentioned in the specification are indicative of the levels of those skilled in the art to which the invention pertains. These patents and publications are incorporated herein by reference to the same extent as if each individual application or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A cash equivalent device for digital currencies comprising:
a microcontroller;
a memory in electrical communication with said microcontroller;
an antenna in electrical communication with said microcontroller; and
wherein said cash equivalent device securely holds a designated cryptocurrency value for circulation, and upon physical handover of said cash equivalent device from a first user to a second user transfers ownership of the designated cryptocurrency value as cash currency, while eliminating the ability of the first user to access the funds stored on the device after handing over the device to the second user.

2. The device of claim 1 wherein the cash equivalent device is in the form of a credit card.

3. The device of claim 1 wherein the cash equivalent device is in the form of a coin.

4. The device of claim 1 wherein the cash equivalent device is in the form of flexible paper currency.

5. The device of claim 1 further comprising a private key generated by the cash equivalent device and stored in said memory, where said private key is never divulged during an entire lifetime of circulation of the cash equivalent device.

6. The device of claim 5 wherein said microcontroller controls read access to said memory storing said private key.

7. The device of claim 5 further comprising a white noise generating electronic circuit;
wherein said private key is a 256 bit random number generated by an algorithm that uses a high entropy white noise signal provided by said white noise generating electronic circuit fed to a designated analog input of said microcontroller or by internal circuitry inside said microcontroller able to generate white noise.

8. The device of claim 7 wherein said algorithm is one of: Yarrow, Fortuna, or Linux “/dev/random”.

9. The device of claim 7 wherein said white noise generator is a zener diode shot noise generator.

10. The device of claim 1 wherein said cash equivalent device is energized by near field communication (NFC) in response to contact with an initialization device or a verification device.

11. The device of claim 1 wherein said cash equivalent device communicates with a verification device or an initialization device via at least one of: near field communication (NFC), Bluetooth Low Energy (BLE), Universal Serial Bus (USB), or One Wire Protocol.

12. A system for circulation of a digital currencies as a cash equivalent, said system comprising:
a cash equivalent device for the circulation of digital currencies, said cash equivalent device securely holding a designated cryptocurrency value for circulation, and upon physical handover of said cash equivalent device from a first user to a second user transfers ownership of the designated cryptocurrency value as cash currency, while eliminating the ability of the first user to access the funds stored on the device after handing over the device to the second user, said cash equivalent device comprising:
a microcontroller;
a memory in electrical communication with said microcontroller;
an antenna in electrical communication with said microcontroller; and
a first private key generated by the cash equivalent device and stored in said memory, where said first private key is never divulged during an entire lifetime of circulation of the cash equivalent device; and
a cryptocurrency address generated from said first private key;
an initialization device of an issuer with a second private key that signs the cryptocurrency address of said cash equivalent device and funds the cryptocurrency address in a blockchain of the digital currency; and
one or more verification devices that conduct a transaction with said cash equivalent device by verifying that said cash equivalent device is genuine and the funded value associated with the cryptocurrency address is available for the transaction.

13. The system of claim 12 wherein said cash equivalent device is energized by near field communication (NFC) in response to contact with said initialization device or said one or more verification devices.

14. The system of claim 12 wherein said cash equivalent device communicates with said verification device or said one or more initialization devices via at least one of: near field communication (NFC), Bluetooth Low Energy (BLE), Universal Serial Bus (USB), or One Wire Protocol.

15. The system of claim 12 wherein said cash equivalent device is in the form of at least one of: a credit card, a coin, or a flexible paper currency.

16. The system of claim 12 wherein said one or more verification devices comprise a mobile phone, a tablet, a laptop, and a desktop computer.

17. A method for circulation of a digital currencies as a cash equivalent at a point of sale or for service transactional commerce, said method comprising:
initializing a cash equivalent device with an initialization device of a funder of said cash equivalent device, where in response to powering up of the cash equivalent device via at least one of: near field communication (NFC), Bluetooth Low Energy (BLE), Universal Serial Bus (USB), or One Wire Protocol said cash equivalent device generates a one-time only first private key and stores the first private key in non-volatile protected memory of said cash equivalent device;
generating a cryptocurrency address in said cash equivalent device with said first private key;
querying said cash equivalent device with said initialization device to obtain the cryptocurrency address and signing the cryptocurrency address with a second private key of said initialization device; and
funding the signed cryptocurrency address in a node of a blockchain of the digital currency.

18. The method of claim 17 further comprising verifying said cash equivalent device with a verification device, said verifying further comprising:
generating a random message by said verification device and sending the random message to said cash equivalent device;
prepending a known message to the received random message by said cash equivalent device and signing a resulting prepended message with the first private key of the cash equivalent device;
sending the signed prepended message to said verification device by said cash equivalent device;
receiving the signed prepended message by said verification device, and checking whether the signed prepended message matches the cryptocurrency address and that the message is signed correctly; and
wherein upon a successful verification said verification device displays a verification confirmation, and said verification device connects to the cryptocurrency address in the blockchain via the Internet to obtain the digital currency balance associated with the cryptocurrency address for display on said verification device.

19. The method of claim 17 further comprising an emptying and decommissioning method for said cash equivalent device, said emptying and decommissioning method comprising:
verifying said cash equivalent device in accordance with claim 18, where based on a successful verification the method further comprises:
generating a transaction by said verification device that moves funds from the cryptocurrency address to an alternative address designated by a user of the verification device;
sending the transaction to said cash equivalent device, which then signs the transaction and records that it has already signed the transaction;
sending the signed transaction by said cash equivalent device to said verification device;
propagating the signed transaction by said verification device by sending the signed transaction to the cryptocurrency address.

20. The method of claim 17 further comprising verification of the emptying and decommissioning of said cash equivalent device, said method of verification of the emptying and decommissioning comprising:
sending a challenge message from said verification device to said cash equivalent device;
prepending a known message to the received challenge message by said cash equivalent device and signing a resulting prepended message with the first private key of the cash equivalent device;
sending the prepended message along with a warning that said cash equivalent device has already signed a transaction to said verification device; and
wherein said verification device displays that said cash equivalent device is now emptied.
